(19) United States
(12) Patent Application Publication
(10) Pub. No.: US 2020/0019192 A1
(43) Pub. Date: Jan. 16, 2020

(54) OBJECT DETECTION AND IMPLEMENT POSITION DETECTION SYSTEM

(71) Applicant: Caterpillar Paving Products Inc., Brooklyn Park, MN (US)

(72) Inventor: Timothy M. O'Donnell, Long Lake, MN (US)

(73) Assignee: Caterpillar Paving Products Inc., Brooklyn Park, MN (US)

(21) Appl. No.: 16/034,428

(22) Filed: Jul. 13, 2018

(51) Int. Cl. G05D 3/20; E01C 23/088; E01C 19/26; E01C 19/42; B62D 6/00; G05D 1/02; E02D 3/02

(52) U.S. Cl. CPC G05D 3/20; E01C 23/088; E01C 19/264; G05D 2201/0202; B62D 6/001; G05D 1/0242; E02D 3/02; E01C 19/42

(57) ABSTRACT

An industrial machine with a frame and a working implement coupled to the frame. A control system is operably coupled to the working implement and includes a three-dimensional sensor that is coupled to the frame. The three-dimensional sensor is positioned to detect information related to the working implement and an object in a surrounding environment.

### TECHNICAL FIELD

This disclosure relates to industrial work machines. More particularly, to a detection assembly of an industrial work machine.

### BACKGROUND

Industrial work machines are often large vehicles that operate to perform a working function. As an example, compactors are machines that include an elongated frame with a compactor barrel system that is a working implement at a front end such that the front of the vehicle moves independent of the back of the vehicle. Object detection and steering articulation are important features in operating these machines. Other machines, such as cold planers, or road mills, have implements, or working systems, such as a conveyor that performs a working function. In addition to the implements, cold planers similar to other machines have tracks with legs that move the frame of the machine vertically with respect to the ground depending on operation.

During operation of these machines, an operator must observe the surroundings of the machine to make determinations regarding steering in relation to objects, implement movement, height requirements, and the like. In some instances sensors are utilized in association with these operations to assist an operator in making decisions and determinations.

These machines are becoming more autonomous, with the machine having a control system that provides more functionality and reduces workload on an operator. Typical autonomous machines such as autonomous vehicles and drones utilize sensors in order to track objects and make determinations about the objects.

As an example, some vehicles utilize three-dimensional position sensors to make determinations such as speed of other vehicles. PCT Publication No. WO2017189185 provides a vehicle with a bumper mounted three-dimensional position sensor system that is capable of making such determinations with the three-dimensional sensor. Still, such systems are typically complex, expensive, and insufficient for industrial machines.

### SUMMARY OF THE INVENTION

In one aspect of the invention an industrial machine is provided with a frame, a working implement coupled to the frame, and a control system operably coupled to the working implement. The control system includes a three-dimensional sensor that is coupled to the frame. The three-dimensional sensor is positioned to detect information related to the working implement and an object in a surrounding environment.

In another aspect of the invention an industrial machine is provide with a frame and a working implement movably coupled to the frame with working implement linkage. A control system is operable coupled to the working implement and includes a three-dimensional sensor positioned to detect information related to the working implement and the working implement linkage. The control system is configured to receive the detected information related to the working implement and the working implement linkage, and move the working implement linkage based on the received detected information related to the working implement linkage.

In yet another aspect of the invention, an industrial machine is provided that includes a frame, a working implement movably coupled to the frame with working implement linkage, and a steering system coupled to the frame. A control system is operably coupled to the working implement and steering system, and includes a three-dimensional sensor positioned to detect information related to the working implement, the working implement linkage, and an object in an environment. The control system is configured to receive the detected information related to the working implement, the working implement linkage, and object in the environment, steer the machine with the steering system based on the information related to the object, move the working implement linkage based on the received detected information related to the working implement linkage, and operate the working implement based on the received detected information related to the working implement.

### BRIEF DESCRIPTION OF THE DRAWINGS

FIG. 1 shows a diagrammatic illustration of an exemplary industrial machine;

FIG. 2 shows a schematic block diagram of an exemplary control system of an industrial machine;

FIG. 3 shows a diagrammatic illustration of an exemplary industrial machine;

FIG. 4 shows a schematic block diagram of an exemplary control system of an industrial machine;

FIG. 5 shows a diagrammatic illustration of an exemplary industrial machine; and

FIG. 6 shows a schematic block diagram of an exemplary control system of an industrial machine.

### DETAILED DESCRIPTION

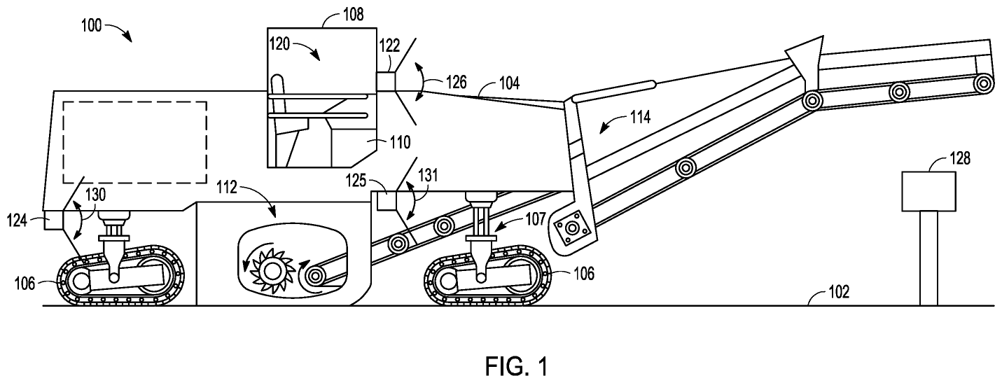

FIG. 1 illustrates portions of an exemplary industrial machine 100. The machine provided is a cold planer; however, other industrial machines, including but not limited to paving vehicles, dump trucks, scarifiers, excavators, backhoes, and the like are contemplated. The machine 100 traverses over a surface 102 such as a roadway, parking lot, concreate pathway, or the like to cut, grind, remove pieces or parts of the surface, or provide some work function or operation. Specifically, the example machine 100 includes a frame 104, tracks 106, track vertical lift linkage 107, cab 108, control system 110, milling system 112, conveyor system 114, and steering system 120. While a vehicle utilizing tracks 106 is presented, alternatively the machine 100 can include wheels. The track vertical lift linkage 107, milling system 112, and conveyor system 114 are each considered a working implement of the cold planer because each provides working functions for the machine. Working implements can also include working implement linkage that couples to or is part of the working implement to move or position the working implement. Similarly, in other examples additional or other implements other than track vertical lift linkage 107, milling systems 112, and conveyor system 114 may be utilized by the machine 100.

The control system 110 includes first, second, and third three-dimensional sensors 122, 124, 125 mounted on the frame 104. While in this example the control system 110 includes first, second, and third three-dimensional sensors 122, 124, 125 in other examples the control system 110 only has a single three-dimensional sensor. In yet another example, the control system 110 includes more than three three-dimensional sensors 122, 124, 125. In another example, at least one three-dimensional sensor 122, 124, 125 is a three-dimensional position sensor. In another example at least one of the three-dimensional sensors 122, 124, 125 is a lidar sensor.

In the example of FIG. 1, the first three-dimensional sensor 122 is mounted to the frame 104 adjacent the cab 108 and includes an angle of detection 126 that includes the conveyor system 116, and the front side of the machine 100. In an example, the first three-dimensional sensor 122 has an angle of detection 126 of 170° degrees. In another example, the first three-dimensional sensor 122 has an angle of detection 126 in a range between and including 150°-170° degrees. In this manner the first three-dimensional sensor 122 detects obstacles or objects 128 such as other vehicles, people, road signs, and the like to provide steering information and also provide information and data related to the operation of the conveyor system 116. In an example, each of the first, second, and third three-dimensional sensors 122, 124, 125 are utilized for location determination including utilizing triangulation, trilateration, or the like. This includes through methodologies including Wi-Fi, geofencing, blue tooth, radio frequency identification (RFID), near field communication (NFC) and the like to determine the position of an object, implement linkage, implement, or the like within the angle of detection 126.

Information related to objects includes distance to the object, size of the object, object movement data, including speed and acceleration data, positioning data, angle of the machine relative to the object, and the like. The information and data related to the operation of the conveyor system 116 includes position of the rollers in the conveyor system 116, position of a conveyor belt, position of either the first stage conveyor or the second stage conveyor, and the like. Thus, as the position of a roller, belt, or conveyor of a conveyor system 116 moves the first three-dimensional sensor is able to detect the changes in position of the roller, belt, or conveyor and such information is provided to the control system 110. The control system 110 then utilizes this information to operate the machine 100, including steering of the machine, conveyor system operations, milling system operations, track vertical lift linkage, implement linkage, or the like.

Thus, the first three-dimensional sensor 122 is positioned and oriented such that the angle of detection 126 is able to capture data and information related to numerous functional operations of the machine 100, including obstacle information, conveyor system information, conveyor belt information, and the like. Thus, the need for numerous sensors for these individual systems are eliminated, reducing overall cost of the machine while providing more information for autonomous operation of the machine by the control system 110.

Similarly, the second and third three-dimensional sensors 124, 125 in one example are mounted to the frame adjacent the tracks 106 and oriented to have angles of detection 130, 131 that include the tracks 106, track vertical lift linkage 107, side of the machine 100, and milling system 112. In an example, the second and third three-dimensional sensors 124, 125 each includes an angle of detection 130, 131 of 170° degrees. In another example, the second and third three-dimensional sensors 124, 125 have angles of detection 130, 131 in a range between and including 150°-170° degrees. In this manner the second and third three-dimensional sensors 124, 125 each detects obstacles or objects 128 such as other vehicles, people, road signs, and the like to provide steering information and also is able to provide information and data related the operation of the tracks 106, track vertical lift linkage 107, and milling system 112.

Data related to objects 128 includes distance to the object, size of the object, object movement data including speed and acceleration data, positioning data, angle of the machine relative to the object, and the like. The information and data related to the operation of the tracks 106 and track vertical lift linkage 107 includes position of the tracks 106 compared to the frame 104, position of the track lift linkage 107 or components compared to the frame 104 or ground 102, movement of the track lift linkage 107 and components, and the like. Thus as the track vertical lift linkage 107 extends or retracts legs of the tracks to move the frame closer or away from the ground, the second and third three-dimensional sensors 124, 125 are able to detect the changes in position of the track lift linkage 107 that is provided to the control system 110. The information and data related to the operation of the milling system include roller speed, position, and the like. The control system 110 then utilizes this information to operate the machine 100, including steering of the machine 100, moving the track lift linkage 107, operating the milling system 112, or other machine systems accordingly.

Thus, the second and third three-dimensional position sensors 124, 125 are positioned and oriented such that the angle of detection 130, 131 are able to capture data and information related to numerous functional operations of the machine 100, including related to obstacle information, track information, track vertical lift linkage information, milling system information, or the like. Thus, the need for numerous sensors for these individual systems are eliminated, reducing overall cost of the machine while providing more information for autonomous operation of the machine by the control system 110.

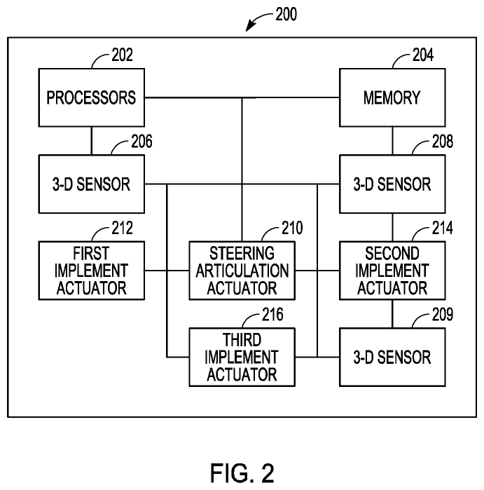

FIG. 2 illustrates a control system 200 of a machine or vehicle that in one example is the control system 110 of FIG. 1. The control system 200 includes one or more processors 202, a memory 204, a first three-dimensional sensor 206, a second three dimensional sensor 208, a third three dimensional sensor 209, a steering articulation actuator 210, a first implement actuator 212, a second implement actuator 214, and a third implement actuator 216.

The one or more processors 202 are coupled to the first three-dimensional sensor 206 to receive data or information related to a first implement and obstacle detection. In one example, the first three-dimensional sensor 206 has an angle of detection of 170°. In another example, the first three-dimensional sensor 206 has an angle of detection in a range between and including 150°-170° degrees. In another example, the first implement is the conveyor system 116 of FIG. 1. Similarly, the one or more processors 202 are coupled to the second three-dimensional sensor 208 and third three dimensional sensor 209 to receive data related to a second implement, a third implement, and obstacle detection. In one example, the second and third three-dimensional sensors 208, 209 each have an angle of detection of 170°. In another example, the second and third three-dimensional sensors 208, 209 each have an angle of detection in a range between and including 150°-170° degrees. In another example, the second implement is the track vertical lift linkage 107 including the tracks 106 of FIG. 1, while the third implement is the milling system 112 of FIG. 1.

Thus, the one or more processors 202 receive information related to objects 128, the first implement, the second implement, and the third implement such as distance to an object, size of the object, object movement data including speed and acceleration data, positioning data, angle of the machine relative to the object, and the like. The one or more processors 202 also receive information related to implement position, implement movement, implement linkage, implement distance from the sensor 206, 208, or 209 implement position to the ground, and the like. Based on the information received, the control system 200 operates the systems of the machine, including through operation of the steering articulation actuator 210, the first implement actuator 212, second implement actuator 214, and/or the third implement actuator 216. Thus, the steering of the machine, along with operation of multiple implements is accomplished with the control system 200 with little to no operator interaction.

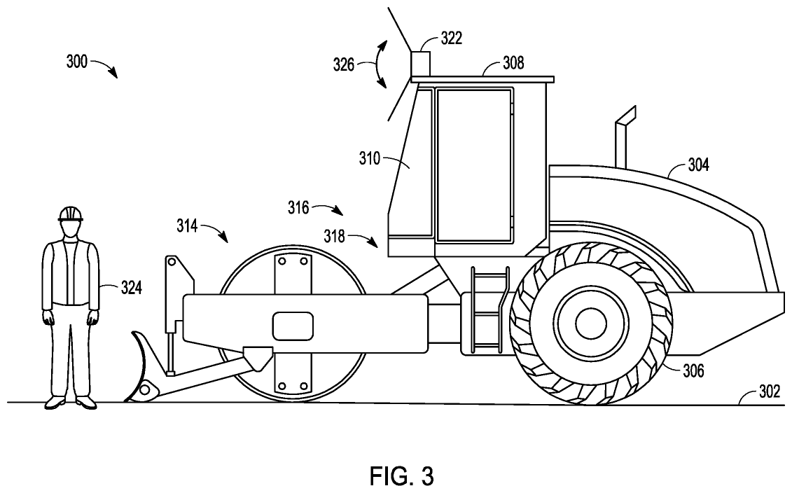

FIG. 3 illustrates yet another example of a machine 300 utilizing a control system that includes a three-dimensional position sensor. In this example, the machine 300 is a compactor that traverses over a surface 302 such as a roadway, parking lot, concreate pathway, or the like to compact the surface. Specifically, the example machine 300 includes a frame 304, wheels 306, cab 308, control system 310, a working implement 314, steering system 316, and steering linkage system 318. While a machine utilizing wheels 306 is presented, alternatively the machine 300 can include tracks. Additionally, working implement 314 in this example is a compactor drum.

The control system 310 includes a three-dimensional sensor 322 mounted on the frame 304 and oriented to capture data related to the frame 304, wheels 306, working implement 314, steering system 316, steering linkage system 318, and objects or obstacles 324 in the environment. In one example, the three-dimensional sensor 322 is mounted on the cab 308. In another example the three-dimensional sensor 322 is mounted on the frame adjacent the working implement 314. In another example, the three-dimensional sensor 322 is a lidar sensor. In yet another example, the three-dimensional sensor 322 has an angle of detection 326 of 170° degrees. In another example, the three-dimensional sensor 322 has an angle of detection 326 in a range between and including 150°-170° degrees. In another example, the obstacles 324 include, people, animals, other vehicles, road signs, landmarks, lane markers, and the like. In an example, the three-dimensional sensor 322 is utilized for location determination including utilizing triangulation, trilateration, or the like. This includes through methodologies including Wi-Fi, geofencing, blue tooth, radio frequency identification (RFID), near field communication (NFC) and the like to determine the position of an object, linkage, implement or the like within the angle of detection 326.

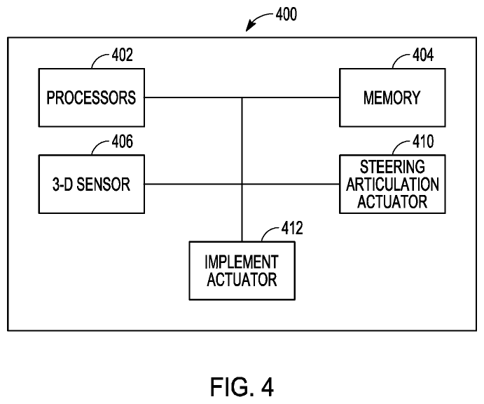

FIG. 4 illustrates a control system 400 of a machine that in one example is the control system 310 of FIG. 3 and the machine is the compactor 300 of FIG. 3. The control system 400 includes one or more processors 402, a memory 404, a three-dimensional sensor 406, a steering articulation actuator 410, and an implement actuator 412.

The one or more processors 402 are coupled to the three-dimensional sensor 406 to receive data related to the implement, steering, and obstacle detection. In one example, the three-dimensional sensor 406 has an angle of detection of 170°. In another example, the three-dimensional sensor 406 has an angle of detection in a range between and including 150°-170° degrees. In yet another example, the data related to steering is detected and transmitted as a result of a steering linkage system being within the angle of detection of the three-dimensional sensor 406. In the example, the steering linkage system is the steering linkage system 318 of FIG. 3 and the angle of detection is the angle of detection 326 of the three-dimensional sensor 322 of FIG. 3.

Thus, the one or more processors 402 receive data related to obstacles 324, the steering system 316, the steering linkage 318 system, and the implement, or compactor barrel system 314 to utilize for processing and operation of the machine 300. In particular, obstacle data received by the control system 400 includes distance to an object, size of the object, object movement data including speed and acceleration data, positioning data, angle of the machine relative to the object, and the like. Steering data received by the control system 400 includes distance of steering linkage 318 to the three-dimensional sensor 322, 406, relative movement of the steering linkage 318 to the three-dimensional sensor 406, angle of wheels, and the like. Implement data received by the control system includes implement, or compactor barrel system 314, movement, implement position, implement rotational speed, and the like. Based on the information received, the control system 400 operates the systems of the machine 300, including through operation of the steering articulation actuator 410, and/or the implement actuator 412. Thus, the steering of the machine, along with operation of at least one implement is accomplished with the control system 400 with little to no operator interaction.

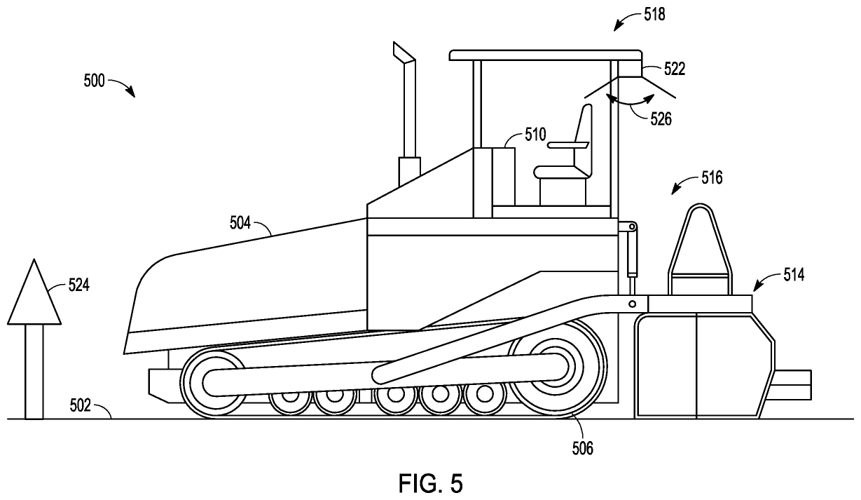

FIG. 5 illustrates yet another example of a machine 500 utilizing a control system that includes a three-dimensional position sensor. In this example, the machine 500 is a paver that traverses over a surface 502 such as a roadway, parking lot, or the like to pave the surface. Specifically, the example machine 500 includes a frame 504, tracks 506, control system 510, working implement 514, working implement linkage 516, and steering system 518. While a machine utilizing tracks 506 is presented, alternatively the machine 500 can include wheels. In this example the working implement 514 is a screed system and the working implement linkage 516 is screed linkage.

The control system 510 includes a three-dimensional sensor 522 mounted on the frame 504 and oriented to capture information related to the working implement, or screed system 514, working implement linkage, or screed linkage 516, steering system 518, and objects or obstacles 524 in the environment. In one example, the three-dimensional sensor 522 is mounted on the cab 508. In another example the three-dimensional sensor 522 is mounted on the frame adjacent the working implement, or screed system 514. In another example, the three-dimensional sensor 522 is a lidar sensor. In yet another example, the three-dimensional sensor 522 has an angle of detection 526 of 170° degrees. In another example, the three-dimensional sensor 522 has an angle of detection 526 in a range between and including 150°-170° degrees. In another example, the objects or obstacles 524 include, people, animals, other vehicles, road signs, landmarks, lane markers, and the like. In an example, the three-dimensional sensor 522 is utilized for location determination including utilizing triangulation, trilateration, or the like. This includes through methodologies including Wi-Fi, geofencing, blue tooth, radio frequency identification (RFID), near field communication (NFC) and the like to determine the position of an object 524, working implement linkage, or screed linkage 516, implement such as the working implement, or screed system 514, or the like within the angle of detection 526.

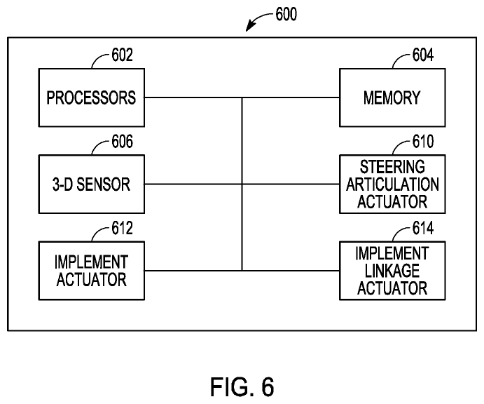

FIG. 6 illustrates a control system 600 of a machine that in one example is the control system 510 of FIG. 5 and the machine is the paver 500 of FIG. 5. The control system 600 includes one or more processors 602, a memory 604, a three-dimensional sensor 606, a steering articulation actuator 610, an implement actuator 612, and an implement linkage actuator 614.

The one or more processors 602 are coupled to the three-dimensional sensor 606 to receive information related to the implement, steering, and obstacle detection. In one example, the three-dimensional sensor 606 has an angle of detection of 170°. In another example, the three-dimensional sensor 606 has an angle of detection in a range between and including 150°-170° degrees.

Thus, the one or more processors 602 receive information related to obstacles, the steering system, and the implement to utilize for processing and operation of the machine. In particular, obstacle information received by the control system 600 includes distance to an object, size of the object, object movement data including speed and acceleration data, positioning data, angle of the machine relative to the object, and the like. Implement information received by the control system includes implement 514 movement, implement 514 position, implement linkage 516 movement, implement linkage 516 position, and the like. Based on the information received, the control system 600 operates the systems of the machine, including through operation of the steering articulation actuator 610, the implement actuator 612, and/or implement linkage actuator 614. Thus, the steering of the machine, along with operation of at least one implement is accomplished with the control system 600 with little to no operator interaction.

### INDUSTRIAL APPLICABILITY

Thus provided are control systems 110, 200, 310, 400, 510, 600 that utilize at least one three-dimensional sensor 122, 124, 125, 322, 522 in order to detect information related to multiple systems or functionalities. In detecting information, the three-dimensional sensor 122, 124, 125, 322, 522 does more than just view an object or implement, instead information such as exact position, distance from the sensor, speed of the implement, or the like is determined. In particular, the three-dimensional sensor 122, 124, 125, 322, 522 is able to detect and thus collect information related to objects within the environment, wheels or tracks of a machine, linkage of an implement, the implement systems such as conveyors, lift linkage, compactor rollers, scarifier systems, screed systems, bucket systems, or the like, for use by a processor 202, 402, 602 of a control system 110, 200, 310, 400, 510, 600. The control system 110, 200, 310, 400, 510, 600 then operates a system of the machine, such as a steering articulation system, implement system, linkage of a system, or the like, based on the information received.

Specifically, the three-dimensional sensors 122, 124, 125, 206, 208, 209, 322, 406, 522, 606 in addition to object detection, are oriented to capture machine implement or linkage distance to determine implement and linkage position. As the linkage or implement are commanded to move by the operator or a control system 110, 200, 310, 400, 510, 600, the distance from the three-dimensional sensors 122, 124, 125, 206, 208, 209, 322, 406, 522, 606 changes and the linkage and/or implement position is again determined. As a result of the large angle of detection of the three-dimensional sensors 122, 124, 125, 206, 208, 209, 322, 406, 522, 606 the sensors 122, 124, 125, 206, 208, 209, 322, 406, 522, 606 detect a variety of linkage and/or implement positions. Thus, operational determinations related to the linkage and implements are made. These can include articulated steering angle, truck bed dump position, excavator linkage positions, wheel loader bucket position, paver screed position, cold planer conveyor position, cold planer leg position, cold planer side plate position, and the like.

As a result of the three-dimensional sensors' 122, 124, 125, 206, 208, 209, 322, 406, 522, 606 ability to detect objects, implement position, and linkage position, improved obstacle avoidance is achieved. The control system 110, 200, 310, 400, 510, 600 monitors the surrounding environment with the three-dimensional sensors 122, 124, 125, 206, 208, 209, 322, 406, 522, 606 for objects 128, 324, 524. In a first example, when an object 128, 324, 524 is detected in the path of the machine, implement, and/or linkage, the control system 110, 200, 310, 400, 510, 600 automatically stops operation of one or more of the machine, implement, and/or linkage to prevent collision. In this manner, the entire machine can be shut down, or alternatively, just the machine, implement, or linkage to avoid the object 128, 324, 524. This includes, but is not limited to stopping operation of the propel system, linkage system, and/or steering system.

In another example, the control system 110, 200, 310, 400, 510, 600 utilizes the three-dimensional sensors 122, 124, 125, 206, 208, 209, 322, 406, 522, 606 to determine the part or portion of a machine, implement, and/or linkage is in the path of an object 128, 324, 524. Based on this information, the control system 110, 200, 310, 400, 510, 600 determines a new path to avoid collision between the machine, implement, or linkage with the object 128, 324, 524. The control system 110, 200, 310, 400, 510, 600 then commands or operates the machine, implement, or linkage to avoid the object 128, 324, 524. This includes by navigating over the determined new path. Additionally, avoidance may occur through operation of a propel system, linkage, implement, steering system, or the like.

In one example, as illustrated in FIGS. 1-2, the machine is a cold planer 100 that has a control system 110 with first, second, and third three-dimensional sensors 122, 124, 125, 206, 208, 209. The first three-dimensional sensor 122, 206 is mounted on the frame 104 and oriented to have an angle of detection 126 to sense information and data related to objects 128 in the environment while at the same time sensing conveyor system information. Such conveyor information includes position of conveyor components, belt data, belt movement data, or the like. The second three-dimensional sensor 124, 208 and third three-dimensional sensor 125, 209 are each mounted on the frame 104 at a different location than the first three-dimensional sensor 122, 206. In one example, the second and third three-dimensional sensors 124, 125, 208, 209 are mounted on the frame 104 and oriented to have an angle of detection 130, 131 to sense information and information related to objects 128 in the environment while at the same time sensing the track legs or posts and the lift linkage 107 of the tracks 106. Such information includes position and height of posts of the tracks 106, position information related to objects 128, and the like.

Once each sensor 122, 124, 125, 206, 208, 209 provides information received by the processor 202 of the control system 110, 200, the processor makes determinations related to the operation of the machine. Such operations include steering of the machine to avoid obstacles, adjustment of components of the conveyor to vary belt tension or conveyor operation, or other such operations. Thus, the control system 110, 200 minimizes human interaction with the machine, simplifying use, and minimizing and eliminating error in operation. Also, by utilizing three dimensional sensors 122, 124, 125, 206, 208, 209 with wide fields of view and oriented on the frame to capture information from multiple systems of the machine and the environment, numerous other system sensors may be eliminated, reducing cost of the control system 110, 200.

Similarly, in other embodiments such as illustrated in FIGS. 3-4 the control system 310, 400 may be utilized in association with other machines such as a compactor. As provided in FIGS. 3-4, the control system 310, 400 includes a three-dimensional sensor 322, 406 mounted on the frame 304 and oriented such that the angle of detection 326 of the three-dimensional sensor 322 receives information related to an object 324 in the environment, the steering linkage system 318, the wheels of the machine, the working implement, or compactor barrel system 314, and the like. Such information is provided to the processor 402 of the control system 310, 400 to make determinations related to steering, compactor system operation, and the like. In one example, the control system 310, 400 moves the steering linkage system based on information detected related to the steering linkage system, and/or based on information related to the object 324. In this manner, based on the detected information related to the steering linkage system and/or object, the control system 310, 400 steers the machine 300. In another example the control system operates the working implement, or compactor barrel system 314 based on the information related to the working implement, or compactor barrel system 314 detected by the three-dimensional sensor 322, 406. Thus, the control system 310, 400 minimizes human interaction with the machine, simplifying use, and minimizing and eliminating error in operation. Also, by utilizing a three-dimensional sensor 322, 406 with a wide angle of detection 326, and oriented on the frame 304 to capture information from multiple systems of the machine and the environment, numerous other system sensors may be eliminated, reducing cost of the control system 310, 400.

In yet another embodiment such as illustrated in FIGS. 5-6, the control system 510, 600 may be utilized in association with other machines such as a paver. With regard to pavers as provided in FIGS. 5-6, the control system 510, 600 includes a three-dimensional sensor 522, 606 mounted on the frame 504 and oriented such that the angle of detection 526 of the three-dimensional sensor 522, 606 receives information related to obstacles 524 in the environment, the wheels or tracks of the machine, the working implement, or screed system 514, the working implement linkage, or screed linkage 516, the steering system 518, and the like. Such information is provided to the processor 602 of the control system 510, 600 to make determinations related to steering, screed system operation, and the like. In one example, the control system 510, 600 determines a distance between the three-dimensional sensor 522, 606 and an object 524 in the environment of the machine 500. In another example, the control system 510, 600 determines, or calculates the distance between the three-dimensional sensor 522, 606 and the implement working linkage, or screed linkage 516. In this example, the control system 510, 606 then moves the screed linkage 516 based in part on this determination to a second position. After the screed linkage 516 is moved to this second position, the control system then determines or recalculates the distance between the three-dimensional sensor 522, 606 and the screed linkage 516. Thus, the control system 510, 600 minimizes human interaction with the machine, simplifying use, and minimizing and eliminating error in operation. Also, by utilizing a three-dimensional sensor 522, 606 with a wide angle of detection 526, and oriented on the frame 504 to capture information from multiple systems of the machine and the environment, numerous other system sensors may be eliminated, reducing cost of the control system 510.

It will be apparent to those skilled in the art that various modifications and variations can be made to the disclosed machine 100, 300, 500 three-dimensional sensor 122, 124, 125, 206, 208, 209, 322, 406, 522, 606 and control system 110, 200, 310, 400, 510, 600 without departing from the scope of the disclosure. Other embodiments of the machine 100, 300, 500 three-dimensional sensor 122, 124, 125, 206, 208, 209, 322, 406, 522, 606 and control system 110, 200, 310, 400, 510, 600 will be apparent to those skilled in the art from consideration of the specification and practice of the methods disclosed herein. It is intended that the specification and examples be considered as exemplary only, with a true scope of the disclosure being indicated by the following claims and their equivalents.

What is claimed is:

1. An industrial machine comprising:
a frame,
a working implement coupled to the frame;
a control system operably coupled to the working implement and including a three-dimensional sensor coupled to the frame and positioned to detect information related to the working implement and an object in a surrounding environment; and
wherein the control system is configured to:
receive the detected information related to the working implement and the object in the surrounding environment;
operate the working implement based on the received detected information related to the working implement; and
steer the machine based on the received detected information related to the object in the surrounding environment.

2. The machine of claim 1, wherein the working implement is a conveyor system.

3. The machine of claim 1, wherein the three-dimensional sensor is a lidar sensor.

4. The machine of claim 1, wherein the three-dimensional sensor is a first three-dimensional sensor and the working implement is a first working implement, further comprising:
a second working implement coupled to the frame; and
a second three-dimensional sensor coupled to the frame and positioned to detect information related to a second working implement coupled to the frame and the surrounding environment.

5. The machine of claim 4, further comprising:
a third working implement coupled to the frame; and
wherein the second three-dimensional sensor detects information related to the third working implement.

6. The machine of claim 5, wherein the control system is further configured to:
receive the detected information related to the second working implement; and
operate the second working implement based on the received detected information related to the second working implement.

7. The machine of claim 6, wherein the control system is further configured to:
receive the detected information related to the third working implement; and
operate the third working implement based on the received detected information related to the third working implement.

8. The machine of claim 7, wherein the first working implement is a conveyor system, the second working implement is track linkage, and the third working implement is a milling system.

9. The machine of claim 1, wherein the working implement is a compactor roller system.

10. The machine of claim 1, wherein the working implement is a screed system.

11. The machine of claim 1, wherein the three-dimensional sensor has an angle of detection that is in a range between and including 150° degrees and 170° degrees.

12. The machine of claim 1, wherein the control system is further configured to:
stop operation of at least one of the machine or working implement based on the received detected information related to the object in the surrounding environment.

13. The machine of claim 1, wherein the control system is further configured to:
move at least one of the machine or working implement based on the received detected information related to the object in the surrounding environment.

14. An industrial machine comprising:
a frame,
a working implement movably coupled to the frame with working implement linkage;
a control system operably coupled to the working implement and including a three-dimensional sensor positioned to detect information related to the working implement and the working implement linkage, the control system configured to:
receive the detected information related to the working implement and the working implement linkage;
move the working implement linkage based on the received detected information related to the working implement linkage;
before moving the working implement linkage, determine a first distance between the three-dimensional sensor and the working implement linkage based on the received detected information related to the working implement linkage; and
after moving the working implement linkage, determine a second distance between the three-dimensional sensor and the working implement linkage based on the received detected information related to the working implement linkage.

15. The machine of claim 14, wherein the control system is further configured to:
detect an object remote to the industrial machine with the three-dimensional sensor; and
determine a distance between the three-dimensional sensor and the detected object.

16. The machine of claim 14, wherein the working implement is a screed system and the working implement linkage is screed linkage of the screed system.

17. The machine of claim 14, wherein the three-dimensional sensor is a lidar sensor.

18. An industrial machine comprising:
a frame,
a working implement movably coupled to the frame with working implement linkage;
a steering system coupled to the frame;
a control system operably coupled to the working implement and steering system, and including a three-dimensional sensor positioned to detect information related to the working implement, the working implement linkage, and an object in an environment, the control system configured to:
receive the detected information related to the working implement, the working implement linkage, and the object in the environment;
steer the machine with the steering system based on the information related to the object,
move the working implement linkage based on the received detected information related to the working implement linkage; and
operate the working implement based on the received detected information related to the working implement.

19. The machine of claim 18, wherein the working implement is a screed system.

20. The machine of claim 18, wherein the three-dimensional sensor has an angle of detection that is in a range between and including 150° degrees and 170° degrees.
